(19) United States
(12) Patent Application Publication
(10) Pub. No.: US 2009/0079884 A1
(43) Pub. Date: Mar. 26, 2009

(54) WIRELESS DISPLAY SYSTEM

(75) Inventor: TAI-AN LIN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/967,010

(22) Filed: Dec. 29, 2007

(30) Foreign Application Priority Data
Sep. 24, 2007 (CN) 200710201836.8

(51) Int. Cl. H04N 5/66

(52) U.S. Cl. 348/739; 348/E07.001

(57) ABSTRACT

An exemplary interactive wireless display system includes a remote sub-system, and a local sub-system. The remote sub-system includes an encoder, a wireless transmitter, and a user interface. The local sub-system includes a wireless receiver, a decoder, a display controller, and a display device. The encoder is configured to encode an input displayable signal. The wireless transmitter is configured to transmit the encoded displayable signal. The wireless receiver is configured to receive the encoded displayable signal. The decoder is configured to decode the encoded displayable signal. The display controller is configured to control the display device to display the decoded displayable signal. The user interface is wirelessly interconnected with the display controller and configured to wirelessly interface with the display device.

### BACKGROUND

1. Technical Field

The invention relates to a wireless display system and, in particular, relates to an interactive wireless display system.

2. Description of Related Art

Wireless display devices have been proposed. These wireless display devices typically include a remote video signal source, and a local display device, which are wirelessly coupled to each other so that the local display device is capable of wirelessly receiving video signals from the remote video signal source, and displays the received video signals at the local end. Unfortunately, such a wireless display device is commonly a one-way communication system; users at the remote end cannot efficiently interface with the local display device.

Therefore, it is desirable to provide an interactive wireless display system, which can overcome the abovementioned problem.

### SUMMARY

In a present embodiment, an interactive wireless display system includes a remote sub-system, and a local sub-system. The remote sub-system includes an encoder, a wireless transmitter, and a user interface. The local sub-system includes a wireless receiver, a decoder, a display controller, and a display device. The encoder is configured to encode an input displayable signal. The wireless transmitter is configured to transmit the encoded displayable signal. The wireless receiver is configured to receive the encoded displayable signal. The decoder is configured to decode the encoded displayable signal. The display controller is configured to control the display device to display the decoded displayable signal. The user interface is wirelessly interconnected with the display controller and configured to wirelessly interface with the display device.

### BRIEF DESCRIPTION OF THE DRAWINGS

Many aspects of the present interactive wireless display system should be better understood with reference to the following drawings. The components in the drawings are not necessarily drawn to scale, the emphasis instead being placed upon clearly illustrating the principles of the present interactive wireless display system. Moreover, in the drawings, like reference numerals designate corresponding parts throughout the several views.

FIG. 1 is functional diagram of an interactive wireless display system in accordance with an embodiment.

FIG. 2 is a schematic, isometric view of the wireless display system of FIG. 1.

### DETAILED DESCRIPTION OF THE EMBODIMENTS

Embodiments of the present interactive wireless display system will now be described in detail with reference to the drawings.

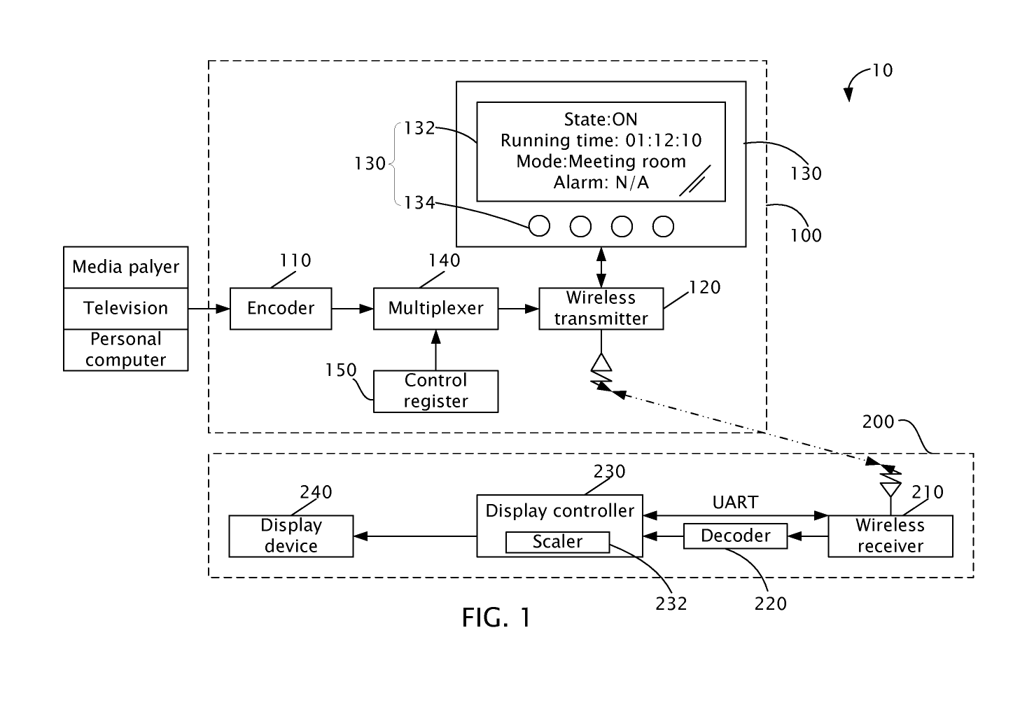

Referring to FIG. 1, an interactive wireless display system 10 in accordance with an embodiment includes a remote sub-system 100, and a local sub-system 200. The remote sub-system 100 includes an encoder 110, a wireless transmitter 120, and a user interface 130. The local sub-system 200 includes a wireless receiver 210, a decoder 220, a display controller 230, and a display device 240. The encoder 110 is configured to encode/compress an input displayable signal. The wireless transmitter 120 is configured to transmit the encoded/compressed displayable signal. The wireless receiver 210 is configured to receive the encoded displayable signal. The decoder 220 is configured to decode/decompress the encoded displayable signal. The display controller 230 is configured to control the display device 240 to display the decoded/decompressed displayable signal. The user interface 130 is wirelessly interconnected with the display controller 230 and configured to wirelessly interface with the display device 240.

The remote sub-system 100 is connected to, for example, a media player (e.g., DVD player or gaming device), a television (TV), or a computer (including various processor-based devices), so as to receive the input displayable signal (e.g., AV signal, TV signal, or computer signal). Accordingly, the encoder 110 is capable of converting the input displayable signal of various formats into a first default format (e.g., MPEG 2 or MPEG 4), and this can be done with software (the encoder 110 is software instructions executed by a processor), hardware, or combination of software and hardware. In practice, in order to be compatible with input of various formats, the remote sub-system 100 further includes a multiplexer 140 and a control register 150. The multiplexer 140 is capable of transmitting, for example, an encoded AV signal, an encoded TV signal, or an encoded computer signal, according to a control flag sent from the control register 150 that is determined by users via, e.g., the user interface 130 or other input devices of the remote sub-system 100. Accordingly, the decoder 220 can be, for example, a hardware-based or software-based MPEG 2, MPEG 4 decoder, and is capable of converting the encoded displayable signal into a second default format (e.g., AV signal) that is receivable by the display device 240.

The wireless transmitter 120 is a part of a wireless short range (<100 meters) transceiver compliant with the Bluetooth standard, and may utilize, for example, a 750 kb/s stream (IEEE 802.15 compliant) in a case that the encoder 110 is a MPEG 4-based encoder, or a 5 Mb/s stream (IEEE 802.11 compliant) if the encoder 110 is MPEG 2 based. Understandably, the wireless transmitter 120 is not limited to this embodiment, but could conform to other suitable radio frequency-based transmitters or infrared transmitters. Accordingly, the wireless receiver 210 is a companion receiver to the wireless transmitter 120, that is, the wireless receiver 210 can be radio frequency-based transmitters or an infrared transmitter that is fully compliant with the wireless transmitter 120.

The user interface 130 typically includes an output device 132 such as display configured to show information to users, and an input device 134 such as keyboard, mouse, or touch screen, configured for user input.

The display controller 230 (e.g., micro control unit (MCU)) is coupled to the decoder 220 so as to receive the decoded displayable signal, and typically includes a scaler 232 configured to scale the decoded displayable signal so that the scaled displayable signal is fittingly shown on the screen of the display device 240. Furthermore, the display controller 230 is interconnected with the wireless receiver 210 via an UART (Universal Asynchronous Receiver/Transmitter) connection, and thereby is interconnected with the user interface 130 so as to receive commands from the user interface 130 (input by users), which is configured to command, via the display controller 230, the display device 240 to perform a function, and feed back information of the display device 240 to the user interface 130, that is, the user interface 130 is wirelessly interface with the display device 240.

The display device 240 can be a display such as a cathode-ray tube (CRT) display, a liquid crystal display (LCD), a plasma display, a light emitting diode (LED) display, or an organic light emitting diode (OLED) display, or a projector such as a CRT projector, a LCD projector, a liquid crystal on silicon (LCoS) projector, a digital light processing (DLP) projector.

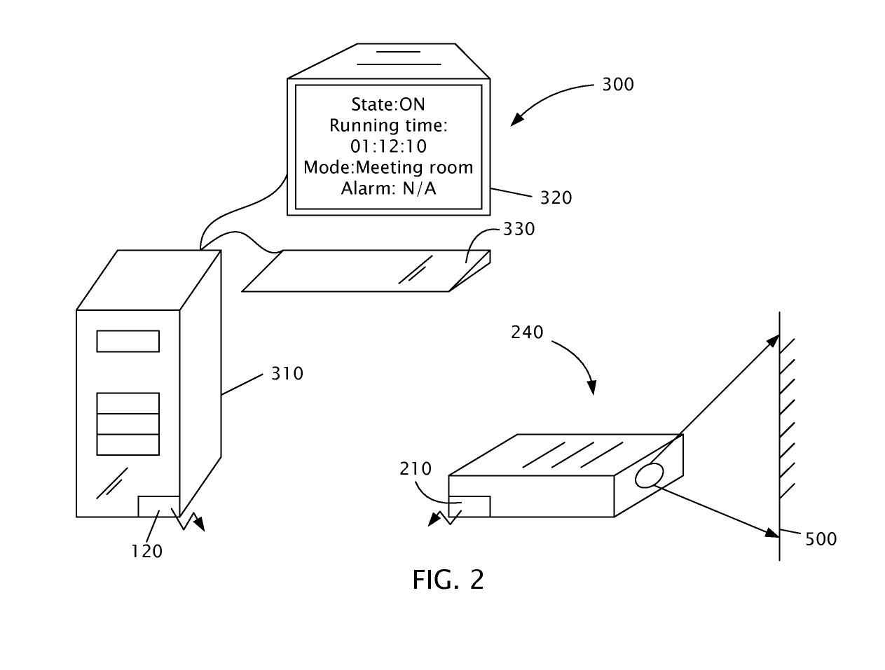

Also referring to FIG. 2, in a detailed embodiment, the remote sub-system 100 is connected to a computer 300 in a control room, and the encoder 110, the wireless transmitter 120, the multiplexer 140, and the control register 150 are integrated into an integrated circuit that is coupled to a peripheral PCB (not shown) in a host 310 of the computer 300. The user interface 130 includes a monitor 320 and a keyboard 330 of the computer 300. A video file is stored in a memory (not shown) of the host 310 and is accessed and played to form a video stream as the displayable signal. This video stream is read by the integrated circuit of the remote sub-system 100, and is encoded, modulated (by the wireless transmitter 120), and transmitted to the local end. The display device 240 is a LCD projector in a meeting room that is far from the control room, and the wireless receiver 210, the decoder 220 and the display controller 230 are housed in the LCD projector. The video stream from the wireless transmitter 120 is received, demodulated (by the wireless receiver 210), decoded, scaled and displayed by the LCD projector on a wall screen 500. Meantime, the LCD projector feeds back, for example, the state, working mode, running information, and/or alarm message to the computer 300 via the UART connection and the wireless network, therefore, users in the control room can favorably control the display device 240.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. An interactive wireless display system comprising:
a remote sub-system comprising:
an encoder configured to encode an input displayable signal; and
a wireless transmitter configured to transmit the encoded displayable signal;
a local sub-system comprising:
a wireless receiver configured to receive the encoded displayable signal;
a decoder configured to decode the encoded displayable signal;
a display device; and
a display controller configured to control the display device to display the decoded displayable signal;
wherein the remote sub-system further comprises a user interface wirelessly interconnected with the display controller via a link between the wireless transmitter and the wireless receiver, the user interface being configured to wirelessly interface with the display device.

2. The interactive wireless display system as claimed in claim 1, wherein the remote sub-system is connected to a displayable signal source selected from a group of: media player, television and computer.

3. The interactive wireless display system as claimed in claim 1, wherein the displayable signal is selected from a group of: audio/video signal, television output signal, and computer output signal.

4. The interactive wireless display system as claimed in claim 1, wherein the encoder is configured for converting the input displayable signal of various formats into a default format.

5. The interactive wireless display system as claimed in claim 4, wherein the default format is selected from a group of: MPEG 2 and MPEG 4.

6. The interactive wireless display system as claimed in claim 1, wherein the remote sub-system comprises a multiplexer and a control register, the multiplexer being configured for transmitting one of various encoded displayable signals, according to a control flag sent from the control register.

7. The interactive wireless display system as claimed in claim 1, wherein the wireless transmitter is a radio frequency-based transceiver or an infrared based transceiver.

8. The interactive wireless display system as claimed in claim 7, wherein the wireless transmitter is a Bluetooth transceiver.

9. The interactive wireless display system as claimed in claim 1, wherein the user interface includes an output device configured to shown feedback information of the display device wirelessly fed back from the display device, and an input device configured for user input.

10. The interactive wireless display system as claimed in claim 9, wherein the input device is selected from a group of: keyboard, mouse, and touch screen.

11. The interactive wireless display system as claimed in claim 1, wherein the wireless receiver is a radio frequency-based transceiver, or an infrared based transceiver.

12. The interactive wireless display system as claimed in claim 11, wherein the wireless receiver is a Bluetooth transceiver.

13. The interactive wireless display system as claimed in claim 1, wherein the display controller is interconnected with the wireless receiver so as to wirelessly couple to the user interface the display device via a universal asynchronous receiver/transmitter connection configured to transmit commands from the user interface and information of the display device fed back from the display controller.

14. The interactive wireless display system as claimed in claim 13, wherein the feedback information comprises at least one of an information group of: state, working mode, running time, and alarm message associated with the display device.

15. The interactive wireless display system as claimed in claim 1, wherein the display controller comprises a scaler configured to scale the displayable signal so that the scaled displayable signal is fittingly shown in display device.

16. The interactive wireless display system as claimed in claim 1, wherein the display device is selected from a group of: cathode-ray tube display, liquid crystal display, plasma display, light emitting diode display, organic light emitting diode display, cathode-ray tube projector, liquid crystal display projector, liquid crystal on silicon liquid crystal projector, and digital light processing projector.
